(19) United States
(12) Patent Application Publication
(10) Pub. No.: US 2006/0225139 A1
(43) Pub. Date: Oct. 5, 2006

(54) Semiconductor integrated circuit

(75) Inventors: Masashi Takada, Kokubunji (JP); Takanobu Tsunoda, Kokubunji (JP); Hiroshi Tanaka, Kokubunji (JP)

Correspondence Address: Stanley P. Fisher;Reed Smith LLP, Suite 1400, 3110 Fairview Park Drive, Falls Church, VA, 22042-4503, US

(73) Assignee: Renesas Technology Corp.

(21) Appl. No.: 11/393,833

(22) Filed: Mar. 31, 2006

(30) Foreign Application Priority Data
Apr. 1, 2005 (JP) JP2005-105812

(51) Int. Cl. H04L 9/32; G06F 12/14; G06F 17/30; G06F 7/04; G06F 11/30; G06K 9/00; H03M 1/68; H04K 1/00; H04L 9/00; H04N 7/16

(52) U.S. Cl. 726/27; 713/193

(57) ABSTRACT

In a dynamic reconfigurable processor, a mechanism for effectively storing configuration data with a small hardware scale and improving processing performance is provided. Also, a sequence mechanism that is easy to be implemented with flexibility and a high operating frequency being both achieved is provided. The configuration data is hierarchically stored, and without suspending a process in a processing unit, configuration data required for subsequent processing is transferred in advance from a first storage area to a second storage area. Also, with a plurality of sequence modes, a condition determination process is performed on different sequence conditions.

### CROSS-REFERENCE TO RELATED APPLICATION

The present application claims priority from Japanese patent application No. JP 2005-105812 filed on Apr. 1, 2005, the content of which is hereby incorporated by reference into this application.

### BACKGROUND OF THE INVENTION

The present invention relates to semiconductor integrated circuits and, particularly, to a technology effective when applied to the configuration of a semiconductor integrated circuit in which logical functions are dynamically reconfigurable.

In recent years, in the field of computer architecture, dynamic reconfigurable technologies have attracted attention. The dynamic reconfigurable technologies are those in which internal logical functions are switched during the operation of an LSI, thereby implementing a function required for processing at required timing. A dynamic reconfigurable processor using such technologies can achieve process performance as high as that of a dedicated LSI by incorporating many processing cells in which logical functions can be switched. Also, such a processor has a feature in which these processing cells can be shared among a plurality of processes through division in a time-domain direction, thereby achieving area-saving compared with the case in which a plurality of dedicated LSI are incorporated.

To implement a different logical function for each processing cell, configuration data defining logical functions is required for each processing cell. Also, to execute processing by switching a plurality of logical functions, each processing cell requires a plurality of pieces of configuration data. As such, since the dynamic reconfigurable processor requires a large amount of configuration data for executing processing, degradation in performance due to transfer of configuration data tends to occur.

To get around the problem, a configuration in which configuration data is stored inside the processor (for example, refer to Design Wave Magazine, CQ Publishing Co., Ltd., August, 2004, Vol. 81, pp. 19-79) and a configuration in which configuration data required for subsequent processing is read in advance (for example, refer to Japanese Patent Laid-Open Publication No. 2004-32016) have been known.

Moreover, processing is suspended when the logical functions are dynamically switched. This causes a time required for changing the configuration data to become an overhead for the processing.

To get around the problem, a configuration have been known in which a sequencer is provided inside the processor and the sequencer controls the change of the configuration data, thereby achieving high speed processing (for example, refer to Design Wave Magazine, CQ Publishing Co., Ltd., August, 2004, Vol. 81, pp. 19-79).

Meanwhile, the inventors have studied the above-described dynamic reconfigurable technologies and the following has become evident.

In general, when various applications are executed on a dynamic reconfigurable processor, an enormous amount of configuration data is required. Therefore, all pieces of configuration data cannot be stored inside the processor.

Therefore, the configuration data is required to be retained in memory outside of the processor. This means a degradation in process performance due to memory access outside the processor. To prevent such a degradation in processing performance, a configuration in which a storage area inside the processor can be efficiently utilized.

That is, reasons for degradation in processing performance of the dynamic reconfigurable processor includes a time required for transferring the configuration data and a time required for changing the configuration data.

For the former, the configuration data required for subsequent processing is read in advance during a process, thereby effectively hiding the configuration data transfer time. However, the configuration described in Japanese Patent Laid-Open Publication No. 2004-32016 is such that the processing unit is divided into a plurality of slots, and the configuration data is written in a halted slot while several slots execute a process. This poses a problem that not all processing units can be effectively used at the same time.

On the other hand, for the latter, that is, in order to reduce a time required for changing the configuration data, as described in Design Wave Magazine, CQ Publishing Co., Ltd., August, 2004, Vol. 81, pp. 19-79, it is effective to provide a sequencer inside the processor. Here, the sequencer desirably handles various types of sequences so as to easily and efficiently implement various application programs. However, such a sequencer capable of handling complex sequences has an increased circuitry size and power consumption, thereby making it difficult to improve an operation frequency.

### SUMMARY OF THE INVENTION

An object and a novel feature of the present invention will be apparent from the description of the present specification and the attached drawings.

Of aspects of the invention disclosed in the present application, those that are typical are briefly described as follows.

That is, a semiconductor integrated circuit according to the present invention includes: a processing unit including a plurality of processing cells for performing a process; a data memory for retaining a process data; a data memory control unit including a plurality of data memory control cells for controlling an access to the data memory; a sequence manager for controlling a state sequence; and a configuration manager for controlling a transfer of configuration data defining logical functions of the processing cells and the data memory control cells, wherein the configuration manager includes a first storage area for storing the configuration data transferred from an external memory via a first bus, each of the plurality of processing cells and the plurality of data memory control cells includes a second storage area for storing the configuration data transferred via a second bus from the configuration manager, and each of the plurality of processing cells and the plurality of data memory control cells can dynamically reconfigure the logic functions by changing the configuration data.

Also, the semiconductor integrated circuit according to the present invention includes: a processing unit including a plurality of processing cells for performing a process; a data memory for retaining a process data; a data memory control unit including a plurality of data memory control cells for controlling an access to the data memory; a sequence manager for controlling a state sequence; and a configuration manager for controlling a transfer of configuration data defining logical functions of the processing cells and the data memory control cells, wherein each of the plurality of processing cells and the plurality of data memory control cells can dynamically reconfigure the logic functions by changing the configuration data. Also, the sequence manager has a first table having stored therein a number provided to a switch destination and a second table having stored therein the number provided to the switch destination, a current number, and a switching condition. Furthermore, the sequence manager has a function of switching between a first mode for use in the first table and a second mode for use in the second table during operation.

Furthermore, the semiconductor integrated circuit according to the present invention includes: a processing unit including a plurality of processing cells for performing a process; a data memory for retaining a process data; a data memory control unit including a plurality of data memory control cells for controlling an access to the data memory; a sequence manager for controlling a state sequence; and a configuration manager for controlling a transfer of configuration data defining logical functions of the processing cells and the data memory control cells, wherein the configuration manager includes a first storage area having stored in the configuration information transferred from an external memory via a first bus, and each of the plurality of processing cells and the plurality of data memory control cells includes a second storage area for storing the configuration data transferred via a second bus from the configuration manager. Also, each of the plurality of processing cells and the plurality of data memory control cells can dynamically reconfigure the logic functions by changing the configuration data. Furthermore, the sequence manager has a first table having stored therein a number provided to a switch destination and a second table having stored therein the number provided to the switch destination, a current number, and a switching condition, and also has a function of switching, during operation, between a first mode of using the first table and a second mode of using the second table.

The effects which are obtained by a typical one among the inventions disclosed in the present application are briefly described below.

A semiconductor integrated circuit with low power consumption or high processing performance can be achieved.

### BRIEF DESCRIPTION OF THE DRAWINGS

FIG. 1 is a block diagram of a construction example of an information processing system including a dynamic reconfigurable processor according to one embodiment of the present invention;

FIG. 2 is a block diagram of a construction example of a sequence manager in the dynamic reconfigurable processor according to one embodiment of the present invention;

FIG. 3 is a block diagram of a construction example of a sequence control register shown in FIG. 2;

FIG. 4 is a drawing of a construction example of a limited sequence control table shown in FIG. 2;

FIG. 5 is a drawing of a construction example of a sequence control table depicted in FIG. 2;

FIG. 6 is a drawing of an operation example of determining a sequence condition in a limited mode in the dynamic reconfigurable processor according to one embodiment of the present invention;

FIG. 7 is a drawing of an operation example of determining a sequence condition in a normal mode in the dynamic reconfigurable processor according to one embodiment of the present invention;

FIG. 8 is a flowchart of a sequence control flow in the dynamic reconfigurable processor according to one embodiment of the present invention;

FIG. 9 is a flowchart, continued from FIG. 8, of the sequence control flow in the dynamic reconfigurable processor according to one embodiment of the present invention;

FIG. 10 is a block diagram of a construction example of configuration manager in the dynamic reconfigurable processor according to one embodiment of the present invention;

FIG. 11 is a block diagram of a construction example of a configuration control register shown in FIG. 10;

FIG. 12 is a block diagram of a construction example of a configuration buffer shown in FIG. 10;

FIG. 13 is a drawing of a construction example of a state define table shown in FIG. 10;

FIG. 14 is a drawing of a construction example of a configuration register management table shown in FIG. 10;

FIG. 15 is a drawing of an operation example of a process of transferring configuration data upon a transfer request in the dynamic reconfigurable processor according to one embodiment of the present invention;

FIG. 16 is a block diagram of a construction example of a bus for transferring configuration data in the dynamic reconfigurable processor according to one embodiment of the present invention;

FIGS. 17A to 17D are drawings of an operation example of a state update process of the configuration manager in the dynamic reconfigurable processor according to one embodiment of the present invention;

FIG. 18 is a flowchart of a configuration control flow in the dynamic reconfigurable processor according to one embodiment of the present invention;

FIG. 19 is a flowchart, continued from FIG. 18, of the configuration control flow in the dynamic reconfigurable processor according to one embodiment of the present invention;

FIG. 20 is a drawing of the configuration of a processing unit in the dynamic reconfigurable processor according to one embodiment of the present invention;

FIG. 21 is a block diagram of a construction example of a processing cell shown in FIG. 20;

FIG. 22 is a drawing of a construction example of a configuration register shown in FIG. 21;

FIG. 23 is a drawing of a construction example of a data memory control unit in the dynamic reconfigurable processor according to one embodiment of the present invention;

FIG. 24 is a block diagram of a construction example of data memory control cells shown in FIG. 23; and

FIG. 25 is a drawing of a construction example of a configuration register shown in FIG. 24.

### DESCRIPTION OF THE PREFERRED EMBODIMENTS

A preferred embodiment of the semiconductor integrated circuit according to the present invention is described below with reference to the attached drawings. Although not particularly restricted, the circuit elements forming each block in the embodiment are formed on one semiconductor board made of, for example, single crystal silicon, through a known semiconductor integration technology for CMOS (complementary metal oxide semiconductor), bipolar transistor, and others. Here, throughout the drawings for describing the embodiments, the same components are denoted with the same reference numeral, and are not repeatedly described.

FIG. 1 depicts an embodiment of an information processing system including a dynamic reconfigurable processor based on the semiconductor integrated circuit according to the present invention.

Although not particularly restricted, a dynamic reconfigurable processor 10 includes a sequence manager 40, a configuration manager 50, a processing unit 60, a data memory control unit 70, a data memory 80, and others, and is formed on one semiconductor board. Inside the dynamic reconfigurable processor 10, the sequence manager 40 is connected to the configuration manager 50, the processing unit 60, and the data memory control unit 70. The configuration manager 50 is connected to the processing unit 60 and the data memory control unit 70 via a second bus. The processing unit 60 is connected to the data memory control unit 70. The data memory control unit 70 is connected to the data memory 80. Also, the dynamic reconfigurable processor 10, a CPU 20, and a memory 30 are connected to a bus (first bus) 90.

The memory 30 includes a configuration storage area that retains, although not shown, a program and data for executing software in the dynamic reconfigurable processor 10 and the CPU 20. Here, the memory 30 is assumed to be a DRAM serving as a main memory and, although not particularly restricted, may be the same chip as that of the dynamic reconfigurable processor 10 and/or the CPU 20 or may be a chip different from that thereof.

The CPU 20 sequentially executes CPU instructions stored in the memory 30, and also controls transfer of control data including configuration data defining logical functions of the dynamic reconfigurable processor 10 and operation data.

The sequence manager 40 performs, based on the control data, management of the internal state of the dynamic reconfigurable processor 10 and control of a state sequence.

The configuration manager 50 includes a configuration buffer (first storage area) 1000 for storing configuration data and controlling transfer of configuration data to the processing unit 60 and the data memory control unit 70.

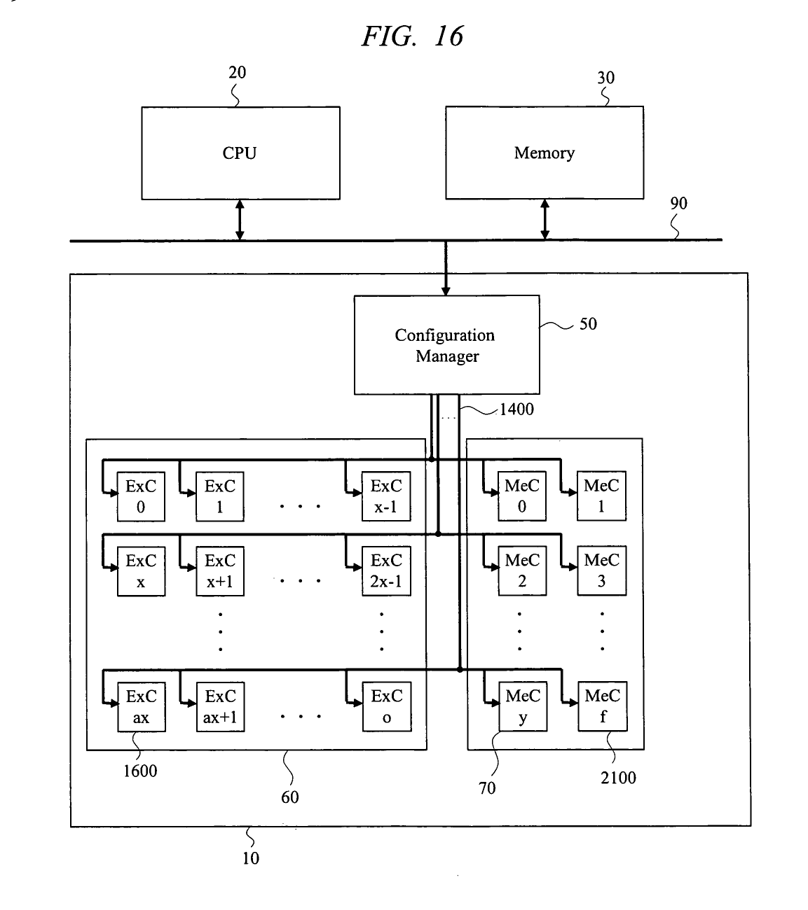

The processing unit 60 includes, for example, a plurality of processing cells 1600 including a configuration register (second storage area) 1800 for storing input configuration data, decoding, and performing processing (refer to FIGS. 16, 20, and 21).

The data memory control unit 70 includes, for example, a plurality of data memory control cells 2100 including a configuration register (second storage area) 2300 for storing input configuration data, decoding, and performing a memory access to the data memory 80 (refer to FIGS. 16, 23, and 24).

Next, in the dynamic reconfigurable processor 10 according to the present embodiment, the detailed configuration and operation of the processing unit 60, the data memory control unit 70, sequence manager 40, and the configuration manager 50 are described.

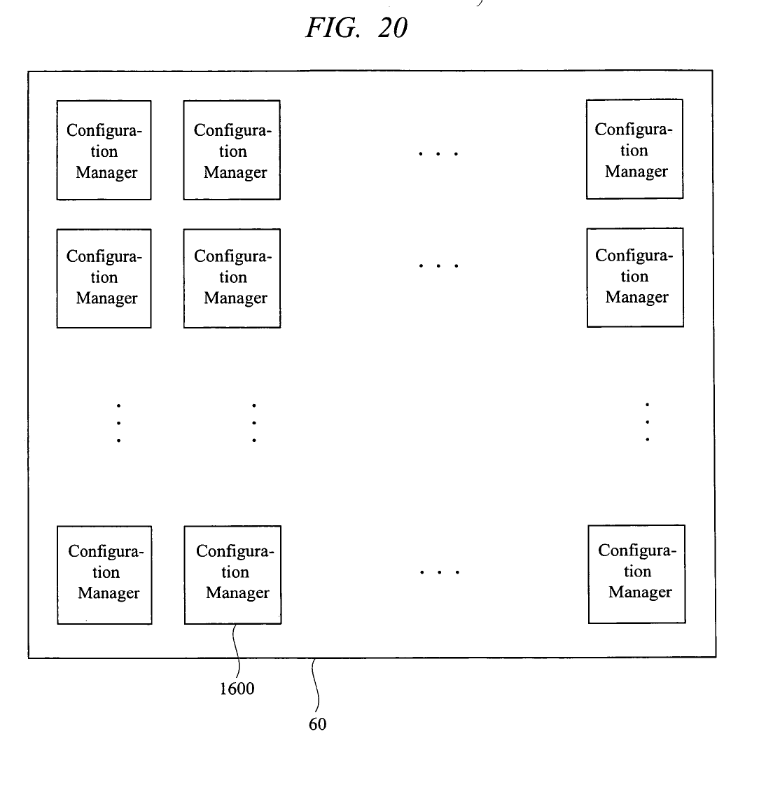

FIG. 20 depicts a construction example of the processing unit 60 in the present embodiment. Although not particularly restricted, the processing unit 60 includes, for example, a plurality of processing cells 1600 capable of dynamically changing an arithmetic and logic operation to be executed depending on the state sequence.

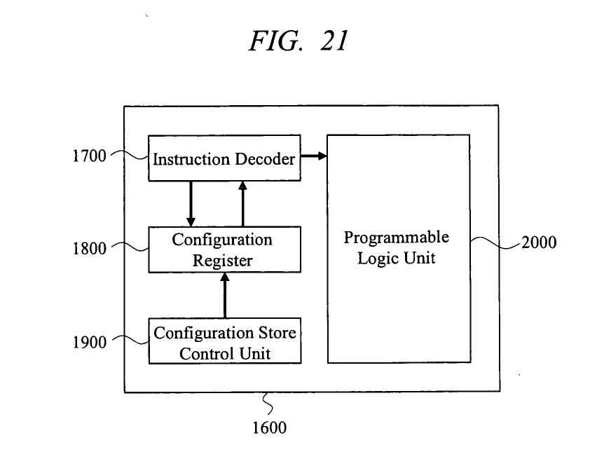

FIG. 21 depicts a construction example of the processing cell 1600 in the present embodiment. Although not particularly restricted, the processing cell 1600 includes an instruction decoder 1700, the configuration register (second storage area) 1800, a configuration store control unit 1900, and a programmable logic unit 2000.

Although not particularly restricted, the instruction decoder 1700 in the present embodiment reads configuration data from the relevant bank of the configuration register 1800 based on a bank number and a sequence request input from the sequence manager 40, and outputs a decoded instruction to the programmable logic unit 2000 (this operation is not shown).

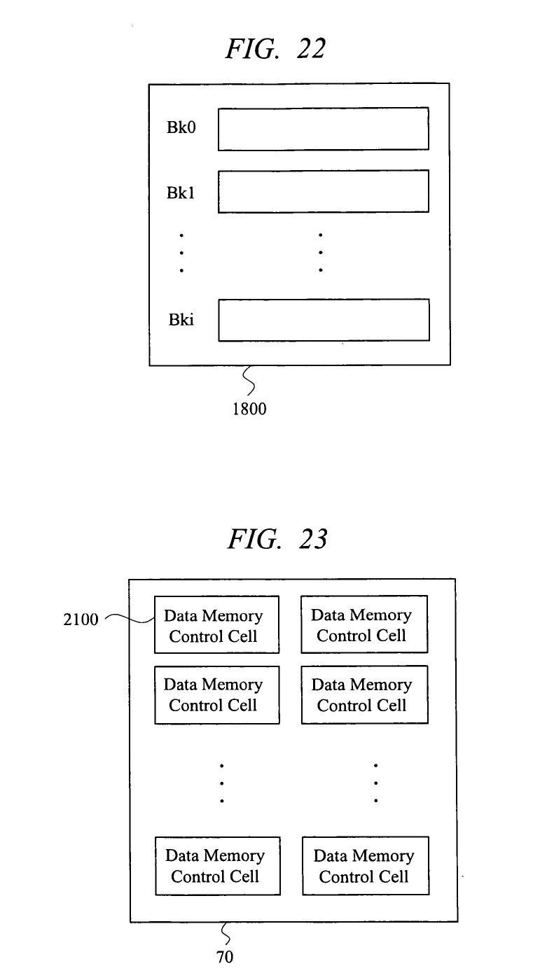

FIG. 22 depicts a construction example of the configuration register 1800 in the present embodiment. Although not particularly restricted, the configuration register 1800 is a register formed of a plurality of banks each having registered therein configuration data. In FIG. 22, Bk0, Bk1, . . . , Bki each represent a bank number. Since the configuration register 1800 is smaller in capacity than the configuration buffer 1000, the configuration register 1800 can perform a high-speed access and support a high-speed state sequence. Also, since the configuration register 1800 is formed of a plurality of banks, different banks are specified as a write bank and a read bank through a process of transferring the above-described configuration data. Then, while configuration data from the configuration manager 50 is written, the configuration data is read to the instruction decoder 1700, thereby efficiently using the processing unit 60.

Although not particularly restricted, the configuration store control unit 1900 in the present embodiment stores the configuration data in a relevant bank of the configuration register 1800 based on a write request, a cell number of the write destination, a bank number of the write destination, and the configuration data input from a configuration manager 50 (this operation is not shown).

Although not particularly restricted, the programmable logic unit 2000 in the present embodiment determines, based on an instruction input from the instruction decoder 1700, an arithmetic and logic operation to be executed and an input/output connection among other processing cells 1600 and data memory control cells 2100 (this operation is not shown).

FIG. 23 depicts a construction example of the data memory control unit 70 in the present embodiment. Although not particularly restricted, the data memory control unit 70 includes, for example, a plurality of data memory control cells 2100 capable of dynamically changing a type of memory access to be executed.

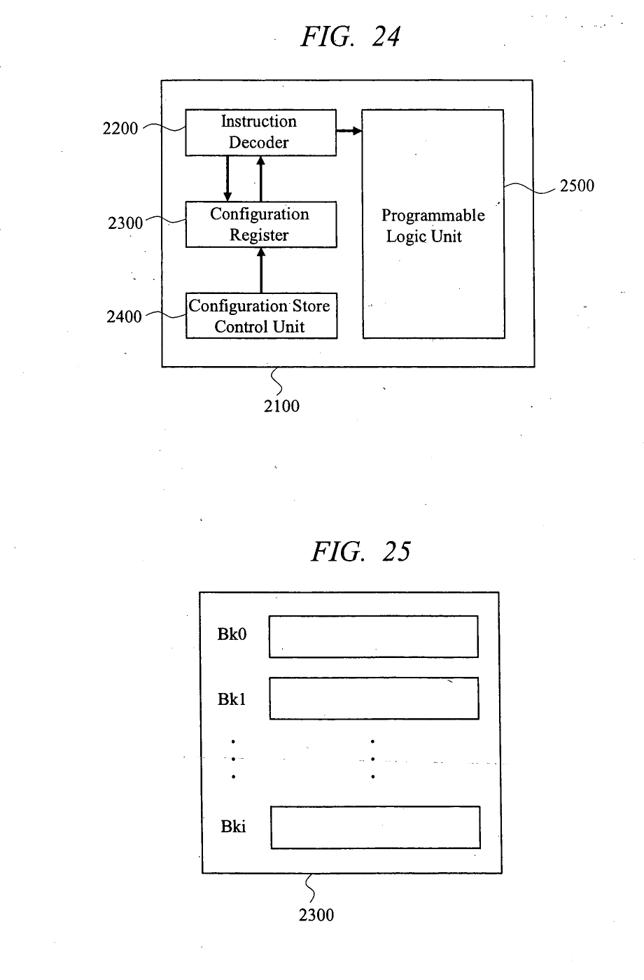

FIG. 24 depicts the data memory control cell 2100 in the present embodiment. Although not particularly restricted, the data memory control cell 2100 includes an instruction decoder 2200, the configuration register (second storage area) 2300, a configuration store control unit 2400, and a programmable logic unit 2500.

Although not particularly restricted, the instruction decoder 2200 in the present embodiment reads configuration data from the relevant bank of the configuration register 2300 based on a bank number and a sequence request input from the sequence manager 40. Also, based on an operation state and an initialization request input from the sequence manager 40, the instruction decoder 2200 performs reading, and outputs a decoded instruction to the programmable logic unit 2500 (this operation is not shown).

FIG. 25 depicts a construction example of the configuration register 2300 in the present embodiment. Although not particularly restricted, the configuration register 2300 is a register formed of a plurality of banks each having the register stored therein configuration data. In FIG. 25, Bk0, Bk1, . . . , Bki each represent a bank number. Since the configuration register 2300 is smaller in capacity than the configuration buffer 1000, the configuration register 2300 can perform a high-speed access and support a high-speed state sequence. Also, since the configuration register 2300 is formed of a plurality of banks, different banks are specified as a write bank and a read bank through a process of transferring the above-described configuration data. Then, while configuration data from the configuration manager 50 is written, the configuration data is read to the instruction decoder 2200, thereby efficiently using the data memory control unit 70.

Although not particularly restricted, the configuration store control unit 2400 in the present embodiment stores configuration data in a relevant bank of the configuration register 2300 based on a write request, a cell number of the write destination, a bank number of the write destination, and the configuration data input from a configuration manager 50.

Although not particularly restricted, the programmable logic unit 2500 in the present embodiment determines, based on an instruction input from the instruction decoder 2200, a type of memory access to be executed and an input/output connection among other data memory control cells 2100 and processing cells 1600 (this operation is not shown).

Here, the configuration registers 1800 and 2300 may be implemented by, for example, RAM or non-volatile memory, and others.

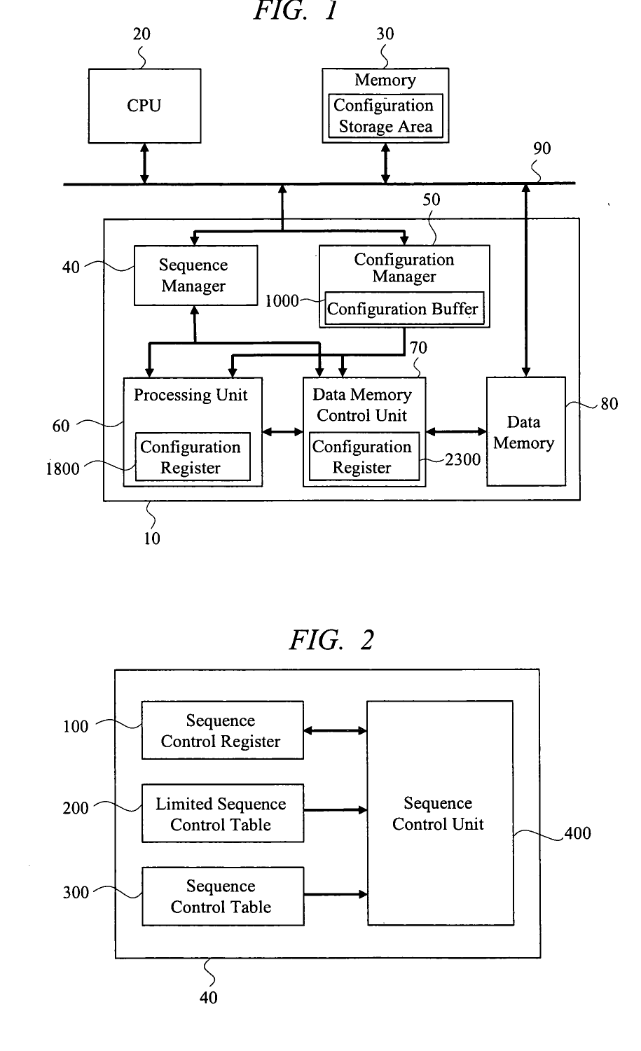

FIG. 2 depicts a construction example of the sequence manager 40 in the present embodiment. Although not particularly restricted, the sequence manager 40 includes a sequence control register 100, a limited sequence control table (first table) 200, a sequence control table (second table) 300, and a sequence control unit 400. The sequence manager 40 performs a sequence condition determination and a sequence process in the sequence control unit 400. The process contents of the sequence condition and the sequence process are described in the limited sequence control table 200 and the sequence control table 300. With the sequence control register 100, a table to be used is specified.

The limited sequence control table 200 is a table restricted so as to be able to handle only a state sequence in which each state can make a transition only to another single state, and has a feature in which, even if the number of states in the table is increased, a sequence condition determination can be performed at high speed. On the other hand, the sequence control table 300 can handle unrestricted state sequences, but, compared with the limited sequence control table 200, requires time for determining a sequence condition. By using these tables of two types and performing a state sequence, a flexible state sequence required for executing various applications can be supported without degrading process performance.

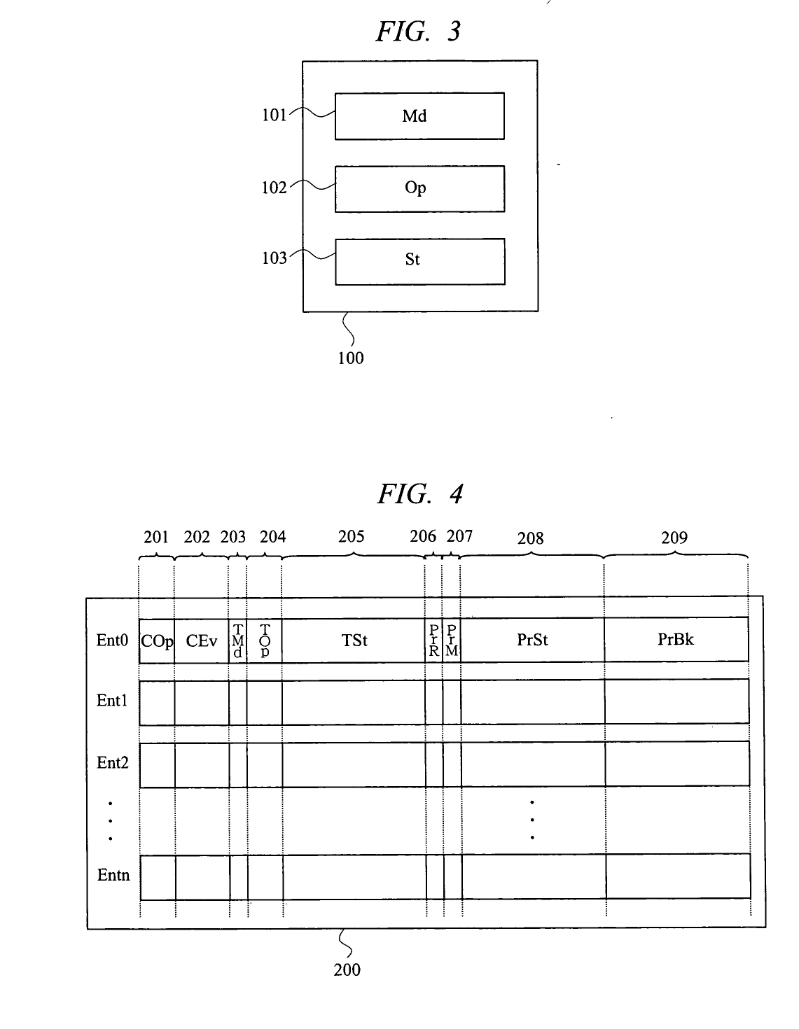

FIG. 3 depicts a construction example of the sequence control register 100 in the present embodiment. Although not particularly restricted, the sequence control register 100 is a register indicating the current state of the dynamic reconfigurable processor 10, and includes three fields 101 to 103. These fields 101 to 103 represent a sequence mode (Md), an operate state (Op), and an active state number (St), respectively. Here, the sequence mode (Md) specifies a table for use in a sequence condition determination and a sequence process. In a limited mode (first mode), the limited sequence control table 200 is used. In a normal mode (second mode), the sequence control table 300 is used. The operate state (Op) indicates a start state or a stop state of the processing unit 60 and the data memory control unit 70. The state number (St) represents a number assigned to each state with a specific logical function formed of all processing cells 1600 in the processing unit 60 and all data memory control cells 2100 in the data memory control unit 70 being taken as one state.

FIG. 4 depicts a construction example of the limited sequence control table 200 in the present embodiment. Although not particularly restricted, the limited sequence control table 200 is a register having described therein a sequence condition regarding a state sequence in which each state can make a transition only to another single state, and a process at the time of such a state sequence, and includes nine fields 201 to 209. In FIG. 4, Ent0, Ent1, Ent2, . . . , Entn each represent an entry number. The entry number uniquely corresponds to one state number (St), and each entry has a description regarding the state sequence of each state. That is, it is not necessary to search for a state number in the table and, even if the number of states to be handled (the number of entries) is increased, a sequence condition determination and a sequence process can be performed at high speed.

The fields 201 and 202 are fields for specifying sequence conditions, and indicate an operate state condition (COp) and an event condition (CEv), respectively. Although not particularly restricted, it is assumed that an event means the number of state sequences, the number of elapsed clock cycles, and others. In consideration of the case where condition settings are not particularly required, the operate state condition (COp) and the event condition (CEv) can be set so as to be unconditionally satisfied. Based on these settings, a sequence condition determination is performed at the sequence control unit 400.

The fields 203 to 205 are fields for specifying a sequence mode after transition (TMd), an operate state after transition (TOp), and a state number after transition (TSt), respectively.

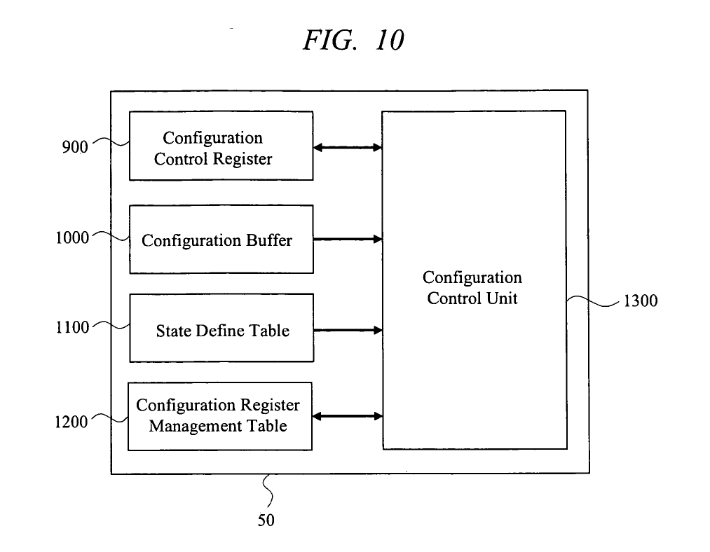

The fields 206 to 209 are fields regarding a process for preloading configuration data required for the subsequent processing from the configuration manager 50 to the processing unit 60 and the data memory control unit 70 at the time of a state sequence, and specify a preload request (PrR), a preload mode (PrM), a preload state number (PrSt), and a preload bank (PrBk), respectively. Although their details will be described further below, the preload request (PrR) indicates whether to preload and transfer configuration data regarding a state after state transition from the configuration buffer 1000 inside the configuration manager 50 (refer to FIGS. 10 and 12) to the configuration register 1800 inside the processing cell 1600 and the configuration register 2300 inside the data memory control cell 2100. The preload mode (PrM) indicates a bank number generation mode indicative of whether to use a preload bank number (PrBk) in the field 209 as a transfer bank number of the configuration data or to generate a preload bank number through a random method. The preload state number (PrSt) indicates a state number corresponding to the configuration data to be preloaded and transferred. The preload bank number (PrBk) indicates a store bank number of the configuration registers 1800 and 2300 formed of a plurality of banks inside the processing cell 1600 and the data memory control cell 2100, respectively, to which the configuration data is to be transferred.

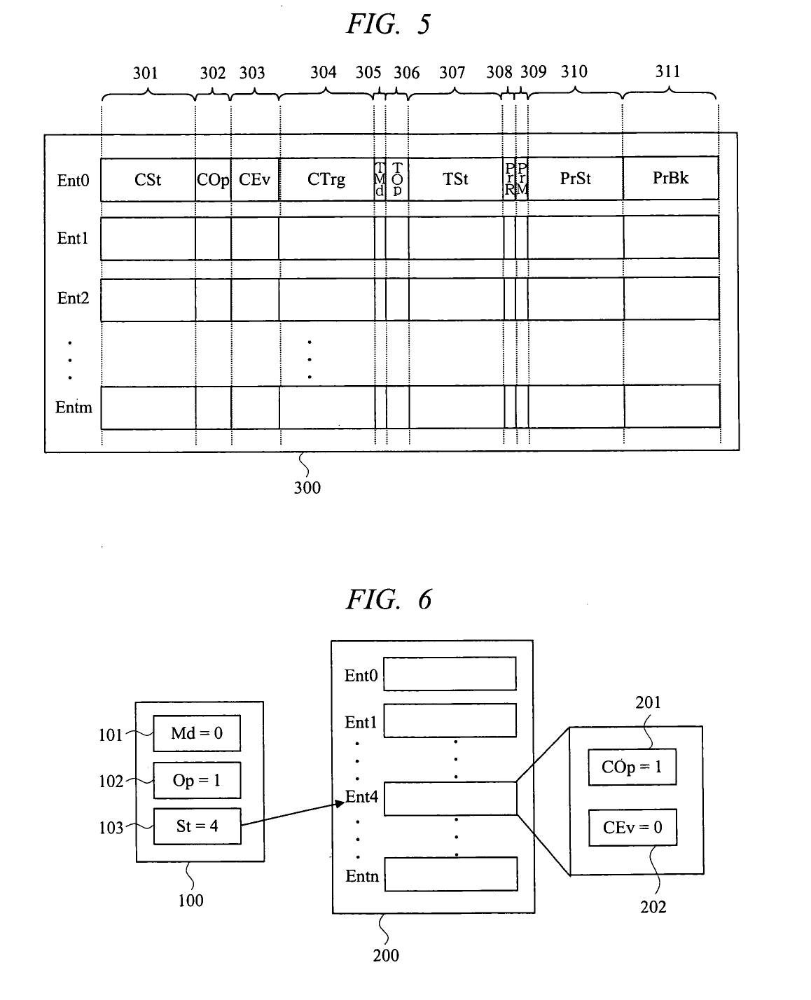

FIG. 5 depicts a construction example of the sequence control table 300 in the present embodiment. Although not particularly restricted, unlike the above-described limited sequence control table 200, the sequence control table 300 is a register having described therein a sequence condition regarding a general state sequence, and a process at the time of such a state sequence, and includes eleven fields 301 to 311. Since entry numbers (Ent0 to Entm) and state numbers in the table do not have a correspondence, each entry has a description regarding a state number and a state sequence of that state. That is, a search for a state number is required in the table. By limiting the number of states to be handled, a sequence condition determination and a sequence process at high speed can be supported.

The fields 301 to 304 are fields for specifying sequence conditions, and indicate a state number condition (CSt), a operate state condition (COp), an event condition (CEv), and a trigger input condition (CTrg), respectively. A trigger is input from the processing unit 60, and is used for performing a state sequence depending on the processing result of the processing unit 60. In consideration of the case where condition settings are not particularly required, the state number condition (CSt), the operate state condition (COp), the event condition (CEV), and the trigger input condition (CTrg) can be set so as to be unconditionally satisfied. Based on these settings, a sequence condition determination is performed at the sequence control unit 400.

The fields 305 to 307 are fields for specifying a sequence mode after transition (TMd), an operate state after transition (TOp), and a state number after transition (TSt), respectively.

The fields 308 to 311 are fields for specifying, for the configuration data, a preload request (PrR), a preload mode (PrM), a preload state number (PrSt), and a preload bank (PrBk), respectively.

The sequence control register 100, the limited sequence control table 200, and the sequence control table 300 may be implemented by, for example, RAM, non-volatile memory, or others. Also, in order to provide hardware with fixed control data optimized particularly for a specific application, the limited sequence control table 200 and the sequence control table 300 may be implemented by ROM or a wired logic.

The sequence control unit 400 performs a sequence control shown in the following (1) to (6) based on the settings on the sequence control register 100, the limited sequence control table 200 and the sequence control table 300.

(1) Sequence Condition Determination

In a sequence condition determination, it is determined whether a condition for a transition from the current state to the next state has been satisfied. Based on the sequence mode (Md) specified in the field 101 of the sequence control register 100, a sequence condition determination is performed using different tables. In the following, a sequence condition determination and a sequence process for each sequence mode are described.

(1-1) Limited Mode

In a limited mode, the limited sequence control table 200 is used to perform a sequence condition determination. First, a relevant entry in the limited sequence control table 200 is specified from the state of the field 101 (Md) of the sequence control register 100. Then, based on the operate state condition (COp) set in the field 201 and the event condition (CEv) set in the field 202 of the specified entry, a condition determination is made to the operate state (Op) in the field 102 of the sequence control register 100 and the occurrence of a predetermined event. If both condition determinations are satisfied, a sequence condition determination in the limited mode is satisfied.

(1-2) Normal Mode

In a normal mode, the sequence control table 300 is used to perform a sequence condition determination. First, the field 301 (CSt) of every entry on the sequence control table 300 are searched. Then, an entry having stored therein a state matching with the state in the field 103 (St) of the sequence control register 100 is selected. Then, as for the selected entry, a condition determination is performed on the operate state (Op) in the field 102 of the sequence control register 100, the occurrence of a predetermined event, and a predetermined trigger, based on the operate state condition set in the field 302, the event condition (CEv) set in the field 303, and the trigger condition (CTrg) set in the field 304 of the sequence control table 300. If all conditions are determined as being satisfied, the sequence conditions in the normal mode are determined as being satisfied. If sequence conditions have simultaneously been satisfied in a plurality of entries on the sequence control table 300, one of the entries in which a sequence condition is satisfied is selected in accordance with a predetermined priority. More preferably, priorities among entries with respect to satisfaction of a sequence condition can be variably set by a register.

(2) Configuration Data Transfer Request Control

If the sequence condition is determined as being satisfied, a request for searching a configuration register management table 1200 (refer to FIG. 10), which will be described further below, is output to the configuration manager 50. The configuration manager 50 performs a search in accordance with the search request. A search hit means that a transfer of the configuration data regarding the transition destination's state has already been completed. In this case, configuration data regarding the state of a further destination to which the state of the transition destination's state makes a transition and onward is preloaded from the configuration buffer 1000 inside of the configuration manager 50 to the configuration register 1800 inside of the processing unit 60 and the configuration register 2300 inside of the data memory control unit 70.

On the other hand, a search error means that configuration data regarding the transition destination's state has not yet been transferred. In this case, a process of transferring the configuration data regarding the transition destination's state is performed. The sequence manager 40 generates, at the time of search hit, a transfer request, a transfer state number, and a preload bank based on, in the limited mode, the settings in the fields 206 to 209 of a relevant entry on the limited sequence control table 200 and, in the normal mode, the settings in the field 308 to 311 of a relevant entry on the sequence control table 300, for output to the configuration manager 50. Here, in the limited mode, based on the setting in the field 207 of the relevant entry on the limited sequence control table 200, it is determined whether to generate a preload bank number from the field 209 of that entry or through a random method. In the normal mode, based on the setting in the field 309 of the relevant entry on the sequence control table 300, it is determined whether to generate a preload bank number from the field 311 of that entry or through a random method. In both sequence modes, the preload bank number may be generated through a scheme other than the random method, for example, an LRU method or a FIFO method. Also, a generation method may be selected based on the settings of the register. On the other hand, at the time of a search error, the state number of the transition destination is taken as a transfer state number, and a preload bank number is generated through a random method. Then a transfer request is generated for output to the configuration manager 50. As described above, the preload bank number may be generated through an LRU method or a FIFO method. Also, a generation method may be selected based on the settings of the register.

(3) State Update Process

In a state update process, if the sequence condition is satisfied, the fields 101 to 103 of the sequence control register 100 are updated, thereby making a transition of the state. Specifically, the fields 203 to 205 (TMd, TOp, TSt) of the relevant entry on the limited sequence control table 200 in the limited mode and the fields 305 to 307 (TMd, TOp, TSt) of the relevant entry on the sequence control table 300 in the normal mode are stored in the fields 101 to 103 (Md, Op, St) of the sequence control register 100.

(4) Sequence Request Control

After the state update process in the above (3), the bank number corresponding to the operate state (Op) in the field 102, the state number (St) in the field 103 of the sequence control register 100, and a sequence request indicative of the occurrence of a state sequence are output to the processing unit 60 and the data memory control unit 70.

(5) Preload Bank Number Change Request Control

During the transfer request control in the above (2), a request for changing a preload bank number input from the configuration manager 50 is received to generate a preload bank number through a random method for output to the configuration manager 50. As described above, the preload bank number may be generated through an LRU method or a FIFO method. Also, the generation method may be selected based on the settings of the register.

(6) State Register Save/Resume Process

During the transfer request control in the above (2), a suspend request may be input from the configuration manager 50. The suspend request is a request that causes the processing unit 60 and the data memory control unit 70 to be suspended and also cause a transition to a state where neither processing nor memory access is performed. If such a suspend request is accepted, execution thereof is suspended, the contents in the field 102 (Op) of the sequence control register 100 are saved to a save state register, and then a transition of the operate state is made to a suspend state. If a resume request is accepted from the configuration manager 50 under the suspend state, the contents of the field 102 (Op) of the sequence control register 100 are resumeed, and then the suspended transfer request control in the above (2) is executed again.

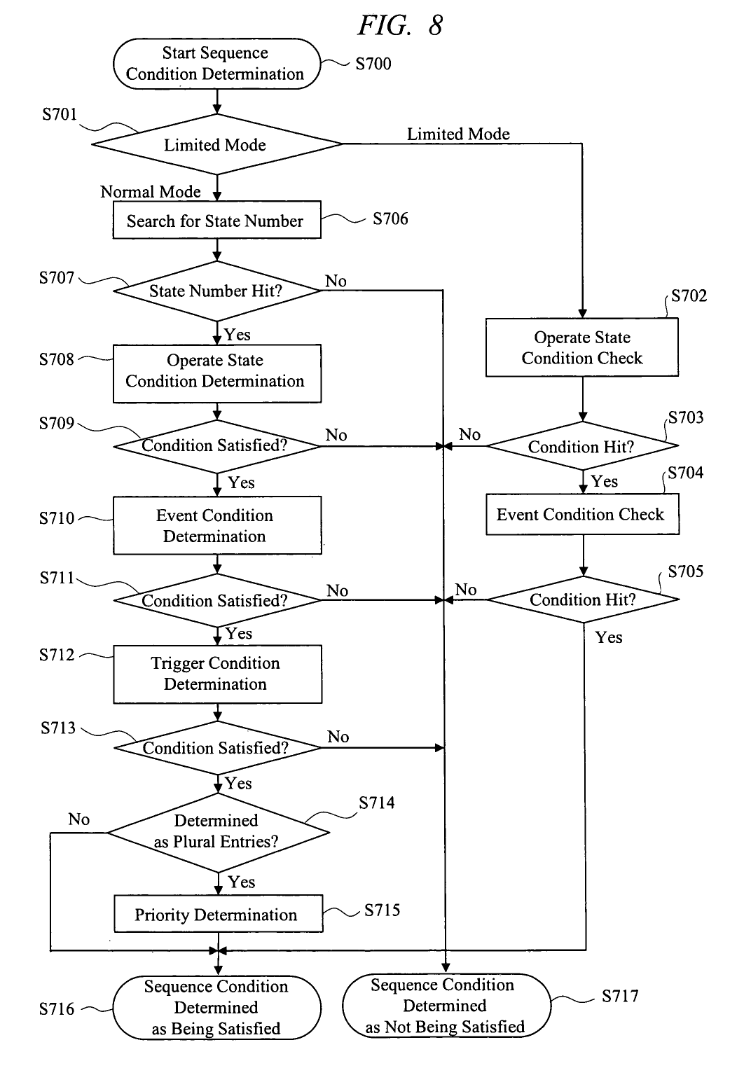

FIG. 8 depicts a sequence condition determination flow. Upon a start of a sequence condition determination (step S700), in accordance with the sequence mode (Md) indicated in the field 101 of the sequence control register 100 (step S701), the sequence control unit 400 performs a sequence condition determination in the limited mode (steps S702 to S705) or a sequence condition determination in the normal mode (steps S706 to S715). If all conditions have been satisfied, the sequence conditions are determined as being satisfied (step S716). If even a single condition has not been satisfied, the sequence conditions are determined as not having been satisfied (step S717).

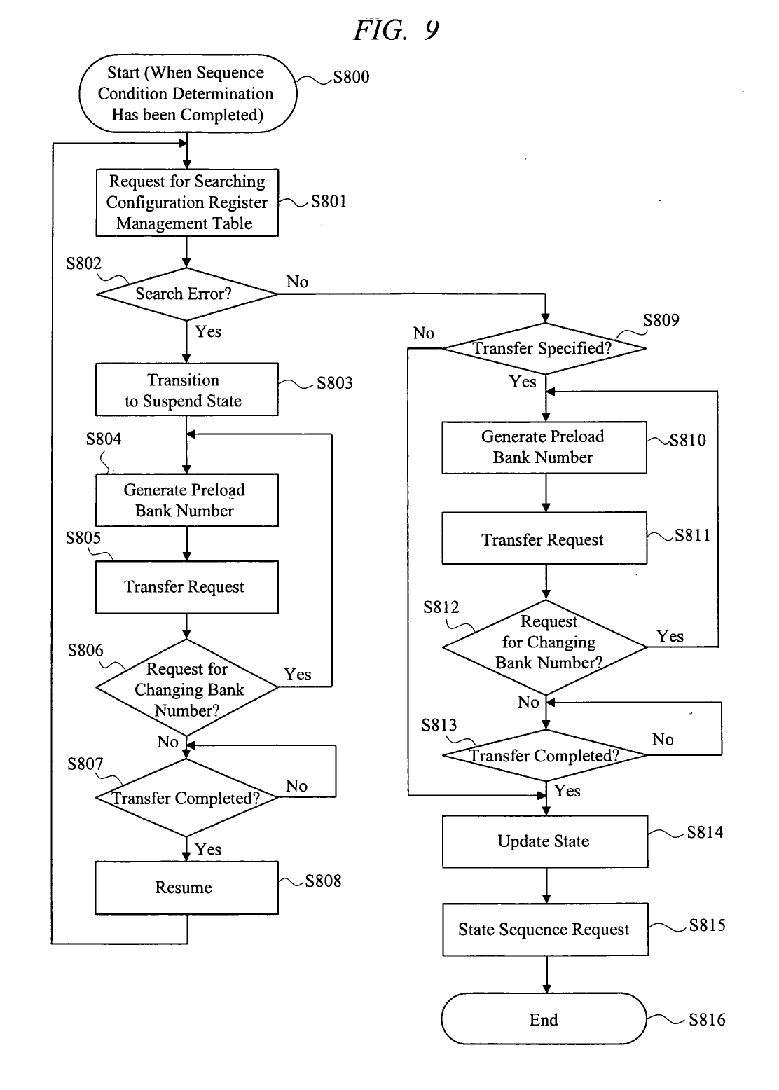

FIG. 9 depicts a sequence process flow after the sequence condition determination. If the sequence conditions are determined as being satisfied (steps S800, S716), a configuration data transfer request control is performed (steps S801 to S812). In the transfer request control, if the search result of the configuration manager 50 for the request for searching the configuration register management table (step S801) indicates “hit”, a transfer request control for performing preload of the configuration data (steps S809 to S812) is performed. If the search result indicates “error”, in response to the suspend request from the configuration manager 50, a transition to a suspend state and saving process of a configuration sequence control register process are preformed (process step S803), and then a transfer request control over the configuration data regarding the state of the transition destination is performed (steps S804 to S806). After completion of the transfer of the configuration data (step S807), in response to a resume request from the configuration manager 50, a process of resumeing the sequence control register (step S808) is performed, and then a transfer request control over the configuration data is performed again. After completion of the transfer of the configuration data (step S813), a state update process (step S814) and a sequence request control (step S815) are performed, and the process ends (step S816).

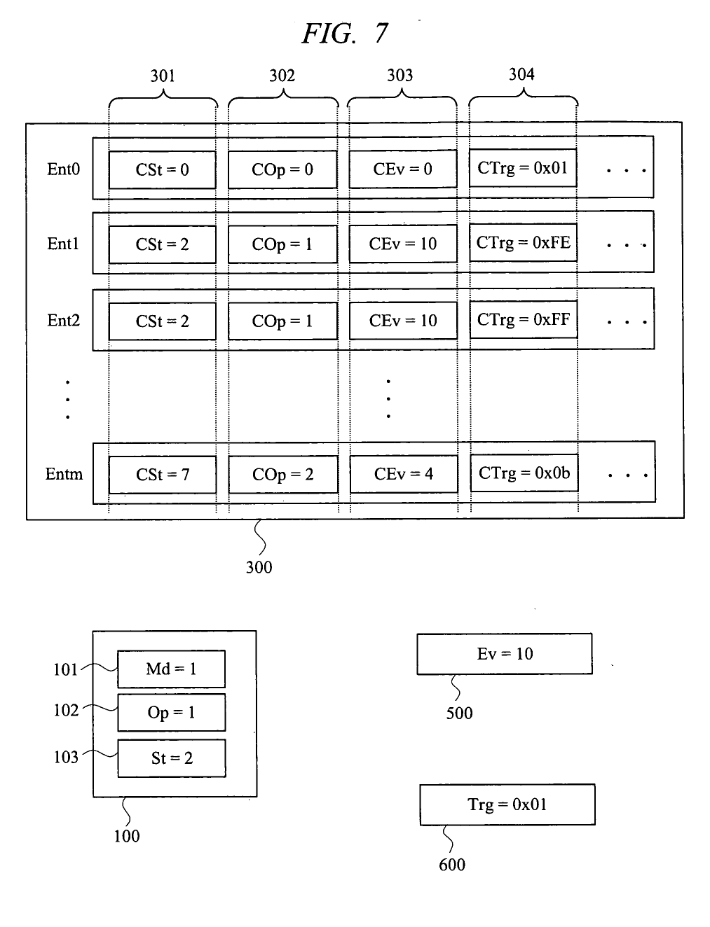

FIGS. 6 and 7 each depict an operation example of a sequence condition determination.

In the operation example in FIG. 6, the value of the field 101 (Md) of the sequence control register 100 is “0”, meaning that the sequence mode is the limited mode. Thus, the limited sequence control table 200 is used for a sequence condition determination. The fields 101 to 103 of the sequence control register 100 are assumed to represent, although not particularly restricted, a value indicative of a sequence mode (Md), a value indicative of an operate state (Op), and a state number (St), respectively. From the contents of the field 103 of the sequence control register 100 (St=4), a relevant entry (Ent4) of the limited sequence control table 200 is specified. Since the value of the field 201 (COp=1) of the relevant entry (Ent4) is equal to the value of the field 102 (Op=1) of the sequence control register 100, the operate state condition has been satisfied. Since the field 202 of the same entry is set as “no event condition required” (CEv=0), the event condition has also been satisfied.

Here, the fields 201 and 202 are assumed, although not particularly restricted, to take a value indicative of an operate condition (COp) and a value indicative of an event condition (CEv), respectively. With the above operation, the sequence condition in the present operation example is determined as being satisfied.

In the operation example in FIG. 7, the value of the field 101 (Md) of the sequence control register 100 is “1”, meaning that the sequence mode is the normal mode. Thus, the sequence control table 300 is used for a sequence condition determination. From the field 103 of the sequence control register 100 (St=2), the field 301 of every entry on the limited sequence control table 200 is searched, and then entries (Ent1, Ent2) having stored therein a relevant state (SCt=2) is selected. Since the value of the field 302 (COp=1) of the relevant entries (Ent1, Ent2) on the sequence control table is equal to the value of the field 102 (Op=1) of the sequence control register 100, the operate state condition for both entries is satisfied. Since the value of the field 303 (CEv=10) of the same entries (Ent1, Ent2) is equal to the value of the event 500 that has occurred (Ev=10), the event condition for both entries is also satisfied.

Although not particularly restricted, in the present operation examples, a logical OR of each bit between the trigger condition and a trigger input is calculated, and it is assumed that the trigger condition is satisfied when all logical ORs are “1”. Here, a logical OR is calculated so as to allow a mask bit to be set. If the trigger condition and the trigger input are required to be in a perfect match with no mask bit allowed to be set, the processing result has to be processed again by using the plurality of processing cells 1600 for an appropriate trigger input, thereby degrading processing performance. The fields 304 (CTrg) of the relevant entries (Ent1, Ent2) indicate “0xFE” and “0xFF”, respectively, and the trigger 600 (Trg) input from the processing unit 60 indicates “00x01”. Therefore, the trigger condition for both entries is satisfied.

Here, although not particularly restricted, the fields 301 to 304 on the sequence control table 300 take a state number (CSt), a value indicative of an operate state condition (COp), a value indicative of an event condition (CEv), and a value indicative of a trigger condition (CTrg), respectively. With this, the sequence condition of both entries (Ent1, Ent2) is determined as being satisfied. Although the priority in the sequence condition determination is not particular restricted, if the priority is set higher as the entry number is smaller, it is selected in the present operation example that, through the priority determination, the sequence condition of the entry 1 (Ent1) is determined as being satisfied.

FIG. 10 depicts a construction example of a configuration manager 50 in the present embodiment. The configuration manager 50 includes a configuration control register 900, the configuration buffer (first storage area) 1000, a condition define table 1100, the configuration register management table 1200, and the configuration control unit 1300. In response to a configuration data transfer request from the sequence manager 40, the configuration control unit 1300 of the configuration manager 50 controls the configuration data to be transferred from the configuration buffer 1000 to the processing unit 60 and the data memory control unit 70. The configuration data transfer control is performed by using the state define table 1100 having described therein an entry number of the configuration buffer 1000 from which the configuration data is to be transferred and numbers provided to the processing cells 1600 and the data memory control cell 2100 to which the configuration data is to be transferred, and the configuration register management table 1200 having described therein which bank of the configuration registers (second storage areas) 1800 and 2300 inside of the processing cell 1600 and the data memory control cell 2100 the transferred configuration data has been stored. The configuration buffer 1000 collectively stores pieces of configuration data common to a plurality of processing cells 1600 and data memory control cells 2100 at one location, and therefore the configuration data can be efficiently stored. On the other hand, the configuration registers 1800 and 2300 inside of the processing cell 1600 and the data memory control cell 2100 are each formed of a register smaller in capacity than the configuration buffer 1000, and therefore high-speed access can be achieved. As such, by hierarchically storing the configuration data, a reduction in required storage capacity and a high-speed state sequence can be achieved.

Also, as shown in FIGS. 21 and 24, the processing cell 1600 and the data memory control cell 2100 incorporate the configuration register 1800 and 2300, respectively, each formed of a plurality of banks inside so as to accept configuration data required for subsequent processing while performing processing and memory access. Thus, by using the configuration register management table 1200, a transfer of the configuration data to an currently active bank is prevented, and whether configuration data regarding the state of the transition destination has been stored in the configuration registers 1800 and 2300 is determined, thereby achieving an efficient transfer of the configuration data.

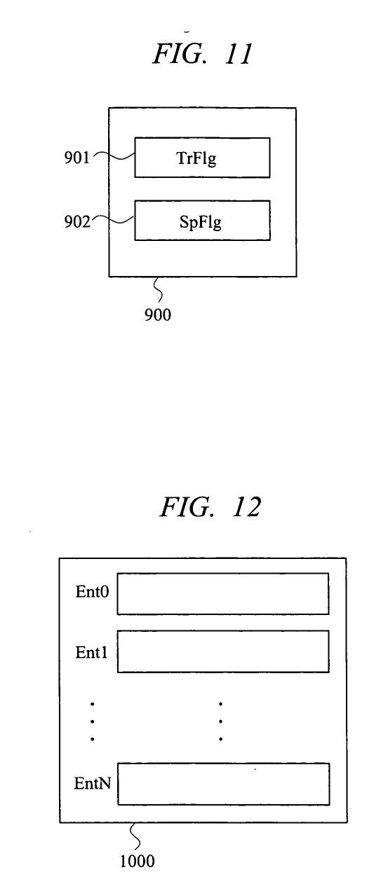

FIG. 11 depicts a construction example of the configuration control register 900 in the present embodiment. Although not particularly restricted, the configuration control register 900 is a register indicating a state of a configuration data transfer process, and includes two fields 901 and 902. The fields 901 and 902 represent a transfer flag (TrFlg) indicative of whether the configuration control unit 1300 is transferring the configuration data and a suspend state flag (SpFlg) indicative of whether the configuration control unit 1300 is suspended, respectively.

FIG. 12 depicts a construction example of the configuration buffer 1000 in the present embodiment. The configuration buffer 1000 is a register having stored therein a number of pieces of configuration data of the processing cells 1600 and the data memory control cells 2100. By collectively storing pieces of configuration data common to a plurality of processing cells 1600 and data memory control cells 2100 as one entry, the configuration data can be efficiently stored. In FIG. 12, Ent0, Ent1, . . . , EntN each represent an entry number.

FIG. 13 depicts a construction example of the state define table 1100 in the present embodiment. Although not particularly restricted, the state define table 1100 is a register in which a pointer indicating an entry in the configuration buffer 1000 is managed for each state, and includes two fields 1101 and 1102. In FIG. 13, St0, St1, . . . , Stn each represent a state number. The fields 1101 and 1102 are fields in which a pointer indicating an entry in the configuration buffer 1000 is stored for all processing cells 1600 inside of the processing unit 60 and all data memory control cells 2100 inside the data memory control unit 70, respectively. In FIG. 13, ExC0, ExC1, ExC2, . . . , ExC0 in the field 1101 and MeC0, MeC1, MeC2, . . . , MeCf in the field 1102 represent numbers provided to the processing cells 1600 and numbers provided to the data memory control cells 2100, respectively (refer to FIG. 16).

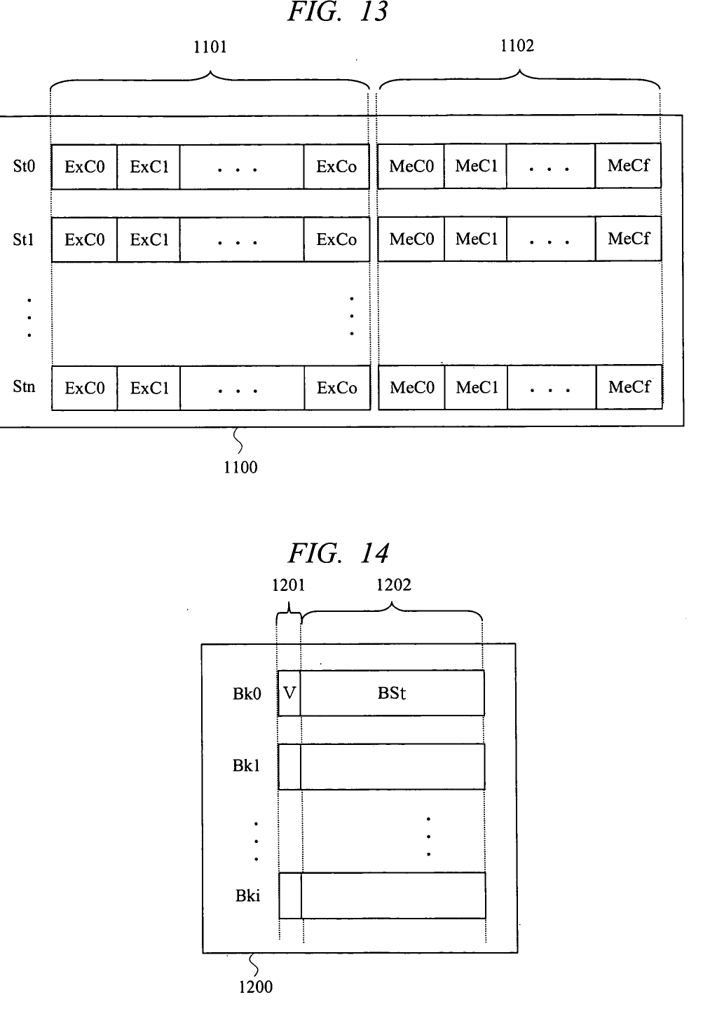

FIG. 14 depicts a construction example of the configuration register management table 1200 in the present embodiment. Although not particularly restricted, the configuration register management table 1200 is a register indicative of which bank of the configuration registers 1800 and 2300 each formed of a plurality of banks inside of the processing cell 1600 and the data memory control cell 2100, respectively, the transferred configuration data has been stored, and includes two fields 1201 and 1202. Since the transfer of the configuration data and the preload banks are managed for each state, the configuration register management table 1200 has stored therein a correspondence between the bank numbers and the state numbers. In FIG. 14, Bk0, Bk1, . . . , Bki each represent a bank number. The fields 1201 and 1202 are fields indicative of validity of configuration data (V) and a state number (BSt), respectively, that are stored in the bank.

Here, the configuration control register 900, the configuration buffer 1000, the state define table 1100, and the configuration register management table 1200 may be implemented by, for example, RAM, non-volatile memory, or others. Also, in order to provide hardware with fixed control data optimized particularly for a specific application, the configuration buffer 1000 and the state define table 1100 may be implemented by ROM or a wired logic scheme.

The configuration control unit 1300 performs a process of transferring the configuration data as shown in the following (1) to (7) based on the settings of the configuration control register 900, the configuration buffer 1000, the state define table 1100, and the configuration register management table 1200 and inputs from the CPU 20 and the sequence manager 40.

(1) Process of Transferring Configuration Data upon a Configuration Data Transfer Request

In a process of transferring configuration data upon a configuration data transfer request, in response to a configuration data transfer request input from the sequence manager 40, a write request, the cell number of the write destination, the bank number of the write destination, and the configuration data are output from the processing unit 60 and the data memory control unit 70. Based on the pointer indicative of the relevant cell number of the relevant state in the state define table 1100, configuration data to be transferred from the configuration buffer 1000 is determined. Here, the state number of the state define table 1100 is specified by a transfer state number input from the sequence manager 40. On the other hand, the write request and the bank number of the write destination are generated from the transfer request and the bank number of the transfer destination input from the sequence manager 40. In the present embodiment, the cell number of the write destination is generated by fixedly determining the order of writing. Alternatively, the order of writing may be variable depending on the settings of the register. If the bank number of the write destination is equal to the bank number in which the configuration data corresponding to the state after transition, the configuration data transfer process is suspended, and then a preload bank number change request is output to the sequence manager 40.

(2) Process of Transferring Configuration Data upon a Configuration Data Transfer Command Request

In a process of transferring configuration data upon a configuration data transfer command request, in response to a configuration data transfer command request input from the CPU 20, a process similar to that in the above (1) is performed. It should be noted herein that the state number of the state define table 1100, the write request for output to the processing unit 60 and the data memory control unit 70, and the bank number of the write destination are a transfer state number, a transfer command request, and a preload bank number, input from CPU 20, respectively.

(3) Configuration Register Management Table Search Process

In a configuration register management table search process, in response to a configuration register management table search request input from the sequence manager 40, whether configuration data regarding the state after transition has been stored the configuration registers 1800 and 2300 inside of the processing cell 1600 and the data memory control cell 2100, respectively, is determined by searching the configuration register management table 1200, and then the search result is output to the sequence manager 40. If a search error occurs, a suspend state flag is set up in the field 902 of the configuration control register 900, and a suspend request is output to the sequence manager 40.

(4) Suspend Request Due to the Occurrence of a State Transition While Configuration Data is Being Transferred

If a state sequence occurs during the configuration data transfer process of the above (1) or (2), a suspend state flag is set up in the field 902 of the configuration control register 900, and then a suspend request is output to the sequence manager 40. The active configuration data transfer process being performed is continued.

(5) Error Notification upon a Configuration Data Transfer Command Request While Configuration Data is Being Transferred

If a configuration data transfer command request is issued from the CPU 20 during the configuration data transfer process of the above (1) or (2), an error notification is made to the sequence manager 40. It is assumed that the process after error depends on the settings of the sequence manager 40.

(6) State Update Process

In a state update process, a state indicative of whether update information is being transferred to the configuration register is set. Specifically, at the time of starting the configuration data transfer, a transfer flag (TrFlg) is set in the field 901 of the configuration control register 900, and then, based on the preload bank number input from the sequence manager 40, the field 1201 (V) of a relevant bank on the configuration register management table 1200 is invalidated. At the time of completion of the configuration data transfer, a transfer flag (TrFlg) in the field 901 of the configuration control register 900 is released, and the field 1201 (V) of the relevant bank on the configuration register management table 1200 is validated. Also, the transfer state number input from the sequence manager 40 is written in the field 1202 (Bst) of the relevant bank.

(7) Resume Request

After the completion of the configuration data transfer process in a suspend state, the suspend state flag in the field 902 of the configuration control register 900 is released, and a resume request is output to the sequence manager 40.

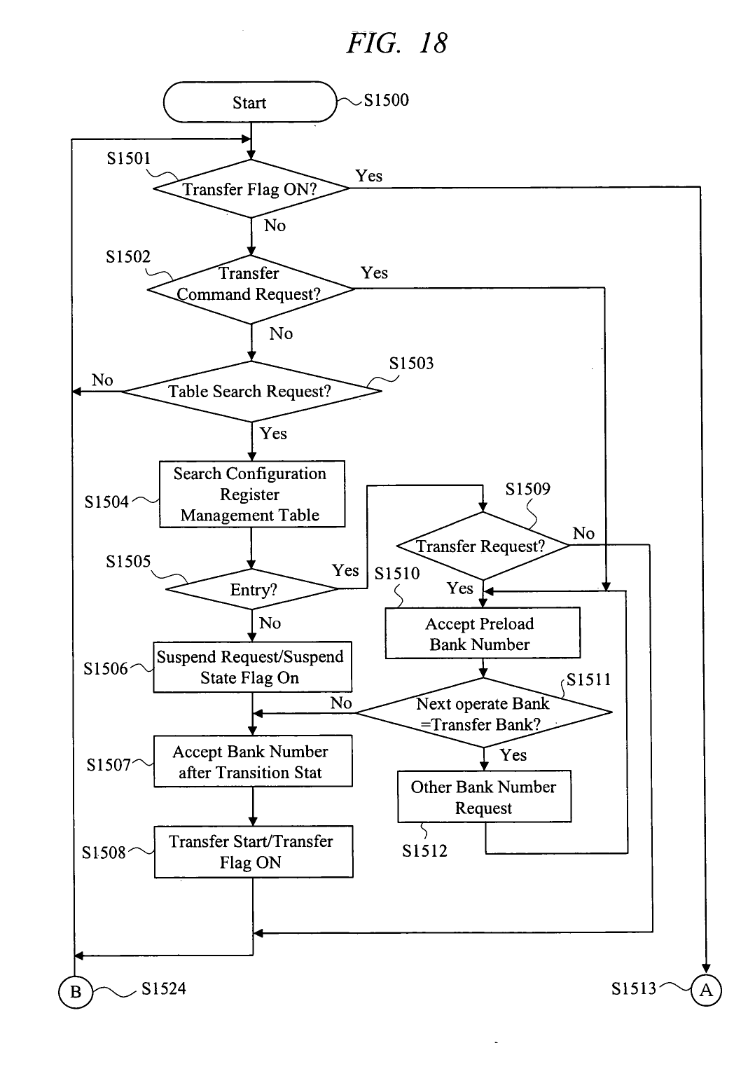

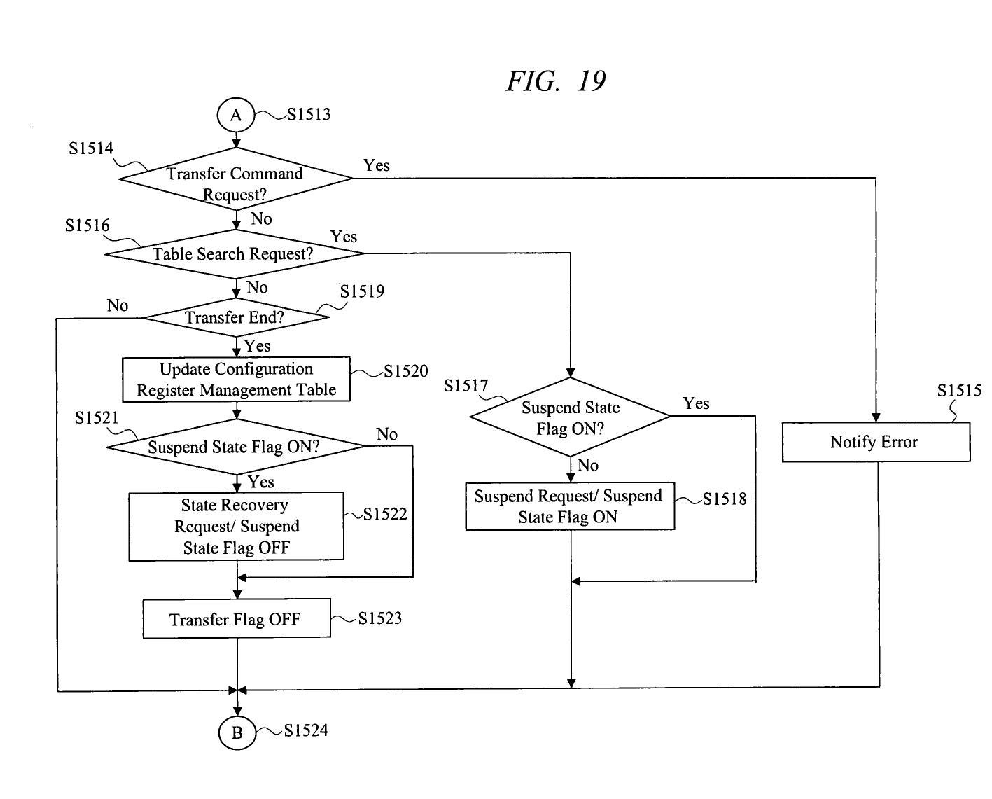

FIGS. 18 and 19 depict a configuration data control flow. Upon a start of a configuration control (step S1500), the configuration control unit 1300 determines the transfer state based on the transfer flag (TrFlg) in the field 901 of the configuration control register 900 (step S1501), and subsequently determines whether a transfer command request from the CPU 20 is present (steps S1502, S1514). If the configuration data is not being transferred or a transfer command request is not present, in response to a configuration register management table search request input from the sequence manager 40 (step S1503), a configuration register management table search process (steps S1504 to S1506) is performed for transferring the configuration data (steps S1507 and S1508 or steps S1509 to S1512, S1508). If the configuration data is not being transferred and a transfer command request is present, a configuration data transfer process based on the transfer command request is performed (steps S1510 to S1512, S1508). If the configuration data is being transferred and a transfer command request is present, an error notification is issued to the sequence manager 40 (step S1515). If the configuration data is being transferred, a transfer command request is not present, and a configuration register management table search request is issued from the sequence manager 40, a suspend request with a state sequence during the transfer of the configuration data is issued (steps S1517, S1518). Upon completion of the transfer of the configuration data (step S1519), a state update process (steps S1520, S1523) is performed. Here, a suspend state flag is set up in the field 902 of the configuration control register 900, a resume request (steps S1521, S1522) is issued to the sequence manager 40.

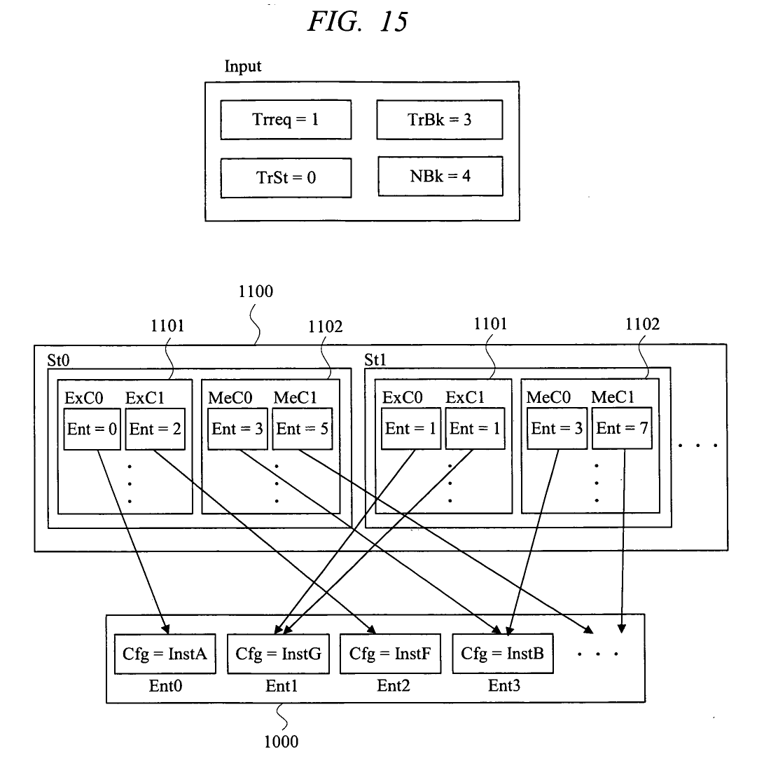

FIG. 15 depicts an operation example of a configuration data transfer process based on a transfer request. In the operation example of FIG. 15, a transfer bank number (TrBk=3) input from the sequence manager 40 is different from a bank number (NBk=4) having stored therein configuration data regarding the state after transition. Therefore, a transfer bank number change request is not present. Also, entry pointers of each cell in the state define table 1100 indicate, as represented by arrows in FIG. 15, entries having stored therein configuration data of the configuration buffer 1000. With common configuration data being stored in the same entry, the configuration buffer 1000 can be efficiently used (Ent1(Cfg=InstG), Ent3(Cfg=InstB)).

As depicted in FIG. 16, in the present embodiment, the configuration is such that, by using a configuration transfer bus (second bus) 1400 that is wider in band than the general-purpose bus (first bus) 90 having connected thereto the dynamic reconfigurable processor 10, the CPU 20, and the memory 30 (that means that the amount of data transfer by unit time in the configuration transfer bus (second bus) 1400 is larger than that in the general-purpose bus (first bus)), configuration data is written in parallel in a plurality of cells of the processing unit 60 and the data memory control unit 70. With this, the time required for a configuration data transfer process is reduced. In FIG. 16, ExC0, ExC1, . . . , ExCo represent numbers provided to the processing cells 1600, whilst MeC0, MeC1, . . . , MeCf represent numbers provided to the data memory control cell 2100. In this operation example, the order of writing is set as first the processing unit 60 and then the data memory control unit 70 and, inside of each unit, writing is performed in ascending order of cell numbers for each row. Alternatively, the order of writing may be variable and can be set by the register. Each processing cell 1600 and data memory control cell 2100 and the configuration manager may be connected via dedicated data lines. However, a large number of dedicated data lines is required, thereby increasing the area of the data lines. To get around this, in the present embodiment, a bus configuration is such that the configuration transfer bus is shared among the plurality of processing cells 1600 or data memory control cells 2100.

Here, description is made only to an operation regarding a first row (a row including ExC0), but a similar operation is performed in parallel on the other rows. Upon a start of transferring the configuration data (FIG. 15), based on the transfer state number (TrSt=0) input from the sequence manager 40 and the write-destination cell number (Wnum=0) generated by the configuration control unit 1300, configuration data (Cfg=InstA) indicated by the entry pointer of ExC0 of St0 in the state define table 1100 is obtained from the configuration buffer 1000. Then, the configuration data (Cfg=InstA) is written in a relevant bank (WBk=3) of a relevant processing cell 1600 (ExC0). Upon completion of writing in the relevant processing cell 1600 (ExC0), the next write-destination cell number is generated (Wnum=1). Then, with a process similar to the above, configuration data (Cfg=InstG) is written in a relevant bank (WBk=3) of a relevant processing cell 1600 (ExC1). Thereafter, the process is performed in a similar manner. Then, after the write process on all rows ends, a write process on each data memory control cell 2100 of the data memory control unit 70 is performed.

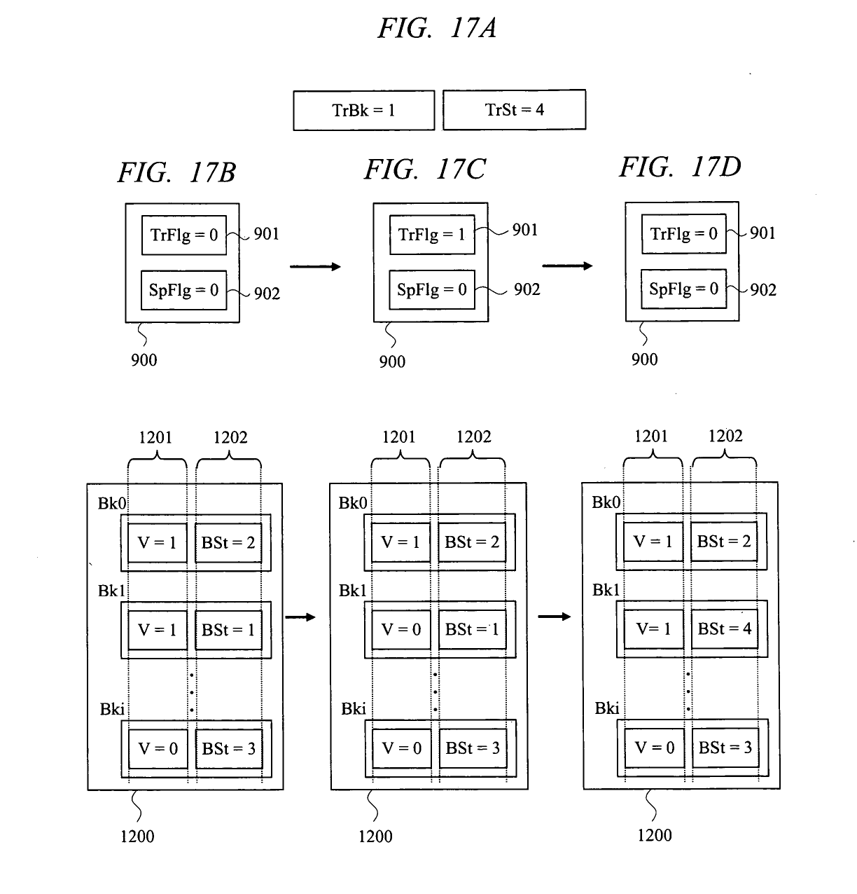

FIG. 17 depicts an operation example of a register state update process. In the operation example, as shown in FIG. 17A, it is assumed that a transfer bank number (TrBk=1) and a transfer state number (TrSt=4) are input from the sequence manager 40. It is also assumed that the configuration control register 900 and the configuration register management table 1200 are in a state as shown in FIG. 17B. Although not particularly restricted, it is assumed that the fields 901 and 902 of the configuration control register 900 take a value indicative of a transfer state (TrFlg) and a value indicative of a suspend state value (SpFlg), respectively, and the fields 1201 and 1202 of the configuration register management table 1200 take a value indicative of validity (V) and a state number (Bst) of a bank, respectively.

Upon a start of a configuration data transfer process, as shown in FIG. 17C, a transfer flag is set up (TrFlg=1) in the field 901 of the configuration control register 900, and the field 1201 of the relevant bank (Bk1) on the configuration register management table 1200 is invalidated (V=0).

Upon completion of the configuration data transfer process, as shown in FIG. 17D, the transfer flag in the field 901 of the configuration control register 900 is released (TrFlg=0), the field 1201 of the relevant bank (Bk1) on the configuration register management table 1200 is validated (V=1), and then a relevant state number (TrSt=4) is written in the field 1202 (BSt=4).

Therefore, according to the semiconductor integrated circuit of the present embodiment, configuration data is hierarchically stored, thereby reducing the storage capacity required inside the processor. Also, by using an internal wide-band bus, a high-speed data transfer is performed among layers. Thus, low power consumption can be achieved, and processing performance can be increased.

Furthermore, without suspending the active process, configuration data required for subsequent processing is transferred in advance among layers, thereby reducing performance overhead.

Still further, by using the limited sequence mode and the sequence mode without limitation in appropriate combination, flexibility in state sequence and a high operating frequency can be both achieved, thereby facilitating implementation.

In the foregoing, the invention devised by the inventorss has been specifically described based on the embodiment. However, as a matter of course, the present invention is not restricted to the above-described embodiment, and can be variously modified without deviating from the gist of the present invention.

The present invention can be applied to a device having implemented thereon a semiconductor integrated circuit in which logical functions are dynamically reconfigurable.

What is claimed is:

1. A semiconductor integrated circuit comprising:
a processing unit including a plurality of processing cells for performing a process;
a data memory for retaining a process data;
a data memory control unit including a plurality of data memory control cells for controlling an access to the data memory;
a sequence manager for controlling a state sequence;
a configuration manager for controlling a transfer of configuration data defining logical functions of the processing cells and the data memory control cells;
a first bus for transmitting the configuration data to the configuration manager; and
a second bus for connecting the configuration manager, and the data memory control unit and the processing unit, wherein
the configuration manager includes a first storage area for storing the configuration data transferred via the first bus,
each of the plurality of processing cells and the plurality of data memory control cells includes a second storage area for storing the configuration data transferred via the second bus from the configuration manager, and
each of the plurality of processing cells and the plurality of data memory control cells can dynamically reconfigure the logic functions by changing the configuration data.

2. The semiconductor integrated circuit according to claim 1, wherein
the first storage area has a plurality of banks capable of storing a plurality of pieces of configuration data.

3. The semiconductor integrated circuit according to claim 2, wherein
Each of the plurality of banks is independently capable of writing and reading.

4. The semiconductor integrated circuit according to claim 1, wherein
an amount of data transfer in the second bus by unit time is larger than an amount of data transfer in the first bus.

5. The semiconductor integrated circuit according to claim 1, wherein
the sequence manager includes a sequence control register capable of setting a plurality of sequence modes, and a sequence control unit for determining whether a sequence condition is satisfied, and
the sequence control unit performs a sequence condition determination operation based on each different sequence condition in accordance with a sequence mode set in the sequence control register.

6. The semiconductor integrated circuit according to claim 5, wherein
the sequence manager includes a plurality of sequence control tables each having stored therein a different sequence condition for each sequence mode, and performs the sequence condition determination operation and a sequence operation in accordance with a sequence control table corresponding to each sequence mode.

7. The semiconductor integrated circuit according to claim 1, wherein
the sequence manager includes a sequence control table with fields allowing a plurality of sequence conditions and a state after transition to be stored therein, and a sequence control unit for determining whether the sequence conditions are satisfied, and
the sequence control unit determines whether the sequence conditions are satisfied in accordance with setting contents of thee sequence control table, and performs a sequence operation.

8. The semiconductor integrated circuit according to claim 7, wherein
the sequence manager includes a plurality of sequence control tables having stored therein a different sequence condition for each sequence mode, and performs a sequence condition determination operation and a sequence operation in accordance with a sequence control table corresponding to each sequence mode.

9. The semiconductor integrated circuit according to claim 1, wherein
the sequence manager generates a preload request for the configuration data when a predetermined sequence condition is satisfied, and
the configuration manager has a function of transferring the configuration information from the first storage area to the second storage area upon the preload request from the sequence manager.

10. The semiconductor integrated circuit according to claim 1, wherein
the second storage area includes a plurality of banks capable of storing a plurality of pieces of configuration data, and is configured so as to be able to store, during a process based on the configuration data stored in a first bank, the configuration data supplied from the configuration manager in a second bank that is different from the first bank.

11. The semiconductor integrated circuit according to claim 10, wherein
the configuration manager has a function of specifying, from among the plurality of banks capable of storing a plurality of pieces of configuration data, non-active banks not corresponding to an active process, and transferring the configuration data to one of the non-active banks.

12. The semiconductor integrated circuit according to claim 10, wherein
the configuration manager has a storage area indicating a correspondence between identifiers for identifying a plurality of states, and the plurality of banks.

13. The semiconductor integrated circuit according to claim 10, wherein
the configuration manager has a storage area for storing a relation between identifiers for identifying a plurality of states, and addresses of a transfer destination and a transfer source of the configuration data in order to transfer the plurality of pieces of configuration data from the first storage area to the second storage area.

14. A semiconductor integrated circuit comprising:
a processing unit including a plurality of processing cells for performing a process;
a data memory for retaining a process data;
a data memory control unit including a plurality of data memory control cells for controlling an access to the data memory;
a sequence manager for controlling a state sequence; and
a configuration manager for controlling a transfer of configuration data defining logical functions of the processing cells and the data memory control cells, wherein
the processing cells and the data memory control cells can dynamically reconfigure the logical functions by changing the configuration data,
the sequence manager has a first table having stored therein a number provided to a switch destination and a second table having stored therein the number provided to the switch destination, a current number, and a switching condition, and
the sequence manager has a function of switching, during operation, between a first mode of using the first table and a second mode of using the second table.

15. The semiconductor integrated circuit according to claim 14, wherein
the configuration manager includes a first storage area having stored in the configuration information transferred from an external memory via a first bus, and
each of the plurality of processing cells and the plurality of data memory control cells includes a second storage area for storing the configuration data transferred via a second bus from the configuration manager.
